(19) United States
(12) Patent Application Publication
(10) Pub. No.: US 2020/0253245 A1
(43) Pub. Date: Aug. 13, 2020

(54) FOOD PREPARATION METHOD

(71) Applicants: Sergeu KOROTKOV, London (GB); Petr KOROTKOV, Ioshkar-Ola (RU)

(72) Inventors: Sergey KOROTKOV, London (GB); Petr KOROTKOV, Ioshkar-Ola (RU)

(21) Appl. No.: 16/859,420

(22) Filed: Apr. 27, 2020

Related U.S. Application Data
(63) Continuation-in-part of application No. 16/068,997, filed on Jul. 10, 2018.

(51) Int. Cl. A23L 5/10

(52) U.S. Cl. CPC A23L 5/13

(57) ABSTRACT

The invention relates to food preparation methods. The technical result of implementing the invention consists in preserving the quality of the food, saving energy used for heating, and reducing the time required for preparation of food. The technical result is achieved by heating of entire volume of water or food inside a container, and subsequently dividing the water or food into a portion to be heated further and a remaining part, where the division occurs after a certain period of time after heating has started. The water or food may be in the liquid, semi-liquid or solid state when placed inside the container.

### CROSS REFERENCE TO RELATED APPLICATIONS AND INCORPORATION BY REFERENCE

This application relates to, and claims priority as a continuation-in-part from U.S. Ser. No. 16/068,997 filed Jul. 1, 2018, the entire contents of which are incorporated herein by reference under 37 CFR 1.57; which in turn claims priority from PCT Ser. No.: PCT/RU2016/000914 filed Dec. 23, 2016, the entire contents of which are also incorporated herein by reference, which in turn claims priority from RU Ser. No.: 2016100777 filed Jan. 12, 2016.

### FIGURE SELECTED FOR PUBLICATION

FIG. 1.

### BACKGROUND OF THE INVENTION

### Field of the Invention

The present invention relates to food preparation methods. More particularly, the present invention provides a method wherein the technical result is achieved by dividing water or food, located in a container, into a portion to be heated and other water.

### Description of the Related Art

Applications of known food preparation methods occur when liquid food or water is heated in a boiling-resistant container or vessel, such as a teakettle, and then, a desired amount thereof is used. The drawbacks of this known method, such as illustrated in GB2242614A is the need to heat the whole amount of liquid food or water even if only some of it is needed for preparation; or the need to pour off some of the water that does not need to be heated, or the need for multiple refills of the vessel with only the amount of water that is needed to be heated. The known method is not practical or suitable for use when part of the food is solid rather than a liquid, or if it is of high viscosity, or in a semi-liquid state.

Heating, and especially multiple re-heating, of the entire amount of water or food regardless of the desired volume results in increased energy consumption, extended heating time, and a shortened lifetime of the vessel. Multiple vessel refills with only the desired amount of water or food or pouring off the portion that does not need to be heated makes the system inconvenient for use and requires more time. In addition, multiple reheating could adversely affect the quality of the food product.

Accordingly, there is a need for a new food preparation method.

### ASPECTS AND SUMMARY OF THE INVENTION

In response, it is now recognized that there is a need for an improved food preparation method.

According to one aspect of the present invention, there is provided a food preparation method, wherein the technical results of implementing the invention consists in preserving the quality of the food, as well as reducing the amount of energy and time necessary for its preparation. The invention involves elements of time control to achieve this. The invention also allows for the possibility of changing the liquid viscosity, where the food product may change from a solid or semi-solid condition to a liquid or semi-liquid condition. The technical result is achieved by dividing water or food at a certain time after heating of entire volume has started, into a portion to be heated further and an additional portion

The above and other aspects, features and advantages of the present invention will become apparent from the following description read in conjunction with the accompanying drawings, in which like reference numerals designate the same elements.

### BRIEF DESCRIPTION OF THE DRAWINGS

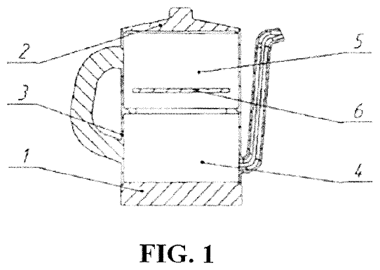

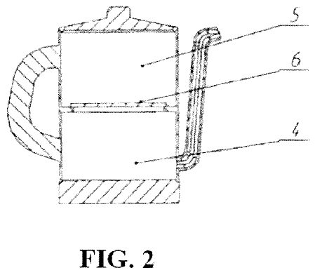

FIG. 1 is a longitudinal cross section illustration of a teakettle.

FIG. 2 is a longitudinal section of the teakettle of FIG. 1 with a shifted and closed screen.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

In the present text, numerous specific details are set forth in order to provide a thorough understanding of exemplary versions of the present invention. It will be apparent, however, to one skilled in the art, that some versions of the present invention may possibly be practiced without some of these specific details. Indeed, reference in this specification to “a variant,” “variants,” and “one/the variant,” or “one version,” “a version” and the like, should be understood to mean that a particular feature, structure, or characteristic described in connection with the variant or version is included in at least one such variant or version according to the disclosure. Thus, the appearances of phrases such as “in one variant,” “in one version,” and the like, in various places in the specification are not necessarily all referring to the same version or variant, nor are separate or alternative versions or variants mutually exclusive of other versions or variants. Moreover, various features may be described which possibly may be exhibited by some variants or versions and not by others. Similarly, various requirements are described which may be requirements for some variants or versions, but not others. Furthermore, as used throughout this specification, the terms ‘a’, ‘an’, ‘at least’ do not denote a limitation of quantity, but rather denote the presence of at least one of the referenced item, in the sense that singular reference of an element does not necessarily exclude the plural reference of such elements. Concurrently, the term “a plurality” denotes the presence of more than one referenced items. Finally, the terms “connected” or “coupled” and related terms are used in an operational sense and are not necessarily limited to a direct connection or coupling.

Various operations may be described as multiple discrete operations in turn, in a manner that may be helpful in understanding embodiments of the present invention; however, the order of description should not be construed to imply that these operations are order dependent.

After the container (kitchenware, kettle, teakettle, teapot, etc.) is filled with water, the amount of water required for heating can be separated from the rest of the water in the container at any time. The essence is in the method, as the water or food can be heated first and divided only after it is heated to provide as much as required at that moment. All processes are completed within the same container. An additional aspect of the present invention is an apparatus for carrying out the invention, as shown herein.

The essence of the invention is that after the container has been filled up with water or food, the amount of water or food required for heating can be separated inside the container after a certain period of time after heating has started. The food may have varying viscosities, including liquid, semi-liquid or may even be in the solid state. The method steps therefore include a step of placing the food or water within the container, a heating step, a waiting step, and then a step of dividing the food or water. There are further optional steps of waiting, heating and then further dividing the food or water.

The entire volume of water or food of different viscosity placed in the container is divided inside the container for a portion to be heated and another portion, after heating starts. The division can be achieved by a device, for example, by a scoop or a ladle, which divides the part to be heated from the remaining portion of water or food. Alternatively, the division can be achieved by use of a sliding partition.

The defined volume of water or food in liquid, semi-liquid (jelly) or solid (frozen, for example, ice cream) condition is placed in the container (e.g. kitchenware) inside which the food is heated to reach the required temperature during the required time. The method can be used for preparing a portion of boiled water from liquid water, but also for preparing a portion of boiled water from crushed ice. Once the water or food has been heated inside the same container the food is divided to a part to be heated further and the part that is not subject to further heating. The part to be heated further is to be heated to the required temperature during required time and is taken out of the container and used. The remaining portion of the food is divided again for a portion to be heated and not heated and the whole process is repeated again required number of times.

The amount of time which has passed before the food or water is divided can be controlled. This can be achieved by the use of timers. The control of the time for heating, waiting and then dividing the food or water can be conducted in automated or in manual mode. The amount of time required for the initial heating step may be pre-determined and could be programmed into a simple timer system or a control system. Likewise, the amount of time which elapses before the division of the water or food may be pre-set into a control system. Alternatively, the division could be manually activated.

Preferably, the division of the water or food may occur after a certain amount of time has elapsed, and this time may be preset into the system so that division occurs automatically. Some embodiments of the invention may have multiple pre-set options for varying the time before division of the water or food. A control system can be used to automate multiple cycles of heating, division, heating the divided portion, and subsequently further dividing the preserved portion for heating. Optionally, the heated portion can also be further divided.

In technical terms, the effect is the reduction of energy consumption and time, required to heat the water or food, which is achieved through the method step where after some time after the container is filled and initial heating of entire volume the water or food inside the container can be divided into a portion to be heated and the remaining unheated portion. This preserves the quality of the water or food, and reduction of time required for the heating of the heated portion. The portion to be heated may be referred to as a first portion, and the remaining unheated portion may be referred to as a second portion, which optionally may subsequently be further divided into a third and fourth portion, and so on, as many times as is necessary. The removal of the food from the container for use may be achieved by pouring the food from the container, for example.

By way of example, the container may be an item of kitchenware, and may appear similar to a kettle. The container may be used, for example, to carry out the process described above for the preparation of a cocktail or a milkshake by a barman in front of a client. This provides a clean, ecological and convenient method for producing the cocktail; minimizing the time and energy spent on the process.

In the example of preparation of a milkshake, the process would entail a first step of placing ice cream into the container. The frozen ice cream would typically have a temperature in the range of −30° C. to −15° C., preferably around −28° C. The ice cream is then heated in the container until it reaches a temperature of −5° C., at which point it becomes soft ice cream, which is fluid under pressure. The soft ice cream is divided into a first portion for heating and a second portion. By way of example, the division may occur using a ladle, which may be heat-insulated, and which may scoop a portion of the ice cream from the whole mass of the ice cream. It may be arranged that the ice cream which remains in the scoop is the portion which is not subject to heating. The ice cream left in the container may be the portion which is heated. The next method step may entail heating the ice cream in the container until it reaches a temperature of 7° C., which is then poured out of the container, and used for making the milk shake. For example, the heated ice cream could be poured into a shaker and mixed with additional ingredients. The method involves heating only the required part of the food (e.g. ice cream) and not the entire volume which was placed in the container. This reduces energy usage, and saves product from exposure of temperature, which reserves the quality of the product.

The application of this method for the preparation of a milkshake is just one example. The method of dividing the fluid may vary. Another example of the application of the method is to divide water which is placed into the container in the solid form of ice. In the same way, the entire volume of ice is heated until some of the ice has melted to the liquid state. After a certain period of time after heating has started, for example, when the water is warmer than 1° C., the water can be divided into a portion to be heated further and a second portion which is not heated further. The part to be heated further can be heated until the required temperature has been achieved.

The same method is also applicable for dividing food have a jelly condition, or a high fat content, or highly viscous liquid foods such as those containing thickening agents, or foods which are partially solid at room temperature. This can include meat jellies, fruit jellies, soups, butter, to name a few examples. Again, the method can be used to divide the food after it has been heated for a certain period of time. This method could also be applied to dough or pastry, for example, which could be used in products such as pies or croissants.

An example of a means for dividing the water or food is a scoop, which may be a thermally insulated scoop. The portion of water or food in the scoop forms the portion which is not to be heated at that time, whilst the portion left in the container (in contact with the heated base portion) continues to heat. The method can be used to heat the entire contents of the container initially, and then to separate out or divide a portion which is removed from the heated portion after a certain amount of time. This separated portion can be reintroduced to the heated section of the container after a certain period of time, which may be specified by a timer, for further heating.

Referring now to FIGS. 1 and 2, the container may appear similar to a kettle. The container comprises a heating base 1, a lid 2, a casing 3, and an internal screen 6. To demonstrate the principals herein, FIG. 1 shows a longitudinal section of a container with an open screen 6 portion, and FIG. 2 shows a longitudinal section of the same container with a shifted and then closed screen 6.

When an entire amount of water or food is to be boiled or heated, screen 6 is in the opened position (FIG. 1). Heating base 1 initially heats up the entire contents of the container, which may be water or food 4, to the desired temperature.

Subsequently, where it is necessary to further heat only part of the water or food in the container, a portion of the water or food is separated, by shifting and then moving screen 6 into the closed position (FIG. 2). The water or food is thus divided into a portion to be further heated 4 and a portion 5 which is reserved at the first temperature. After dividing the water or food, a certain period of time may elapse, and then the required amount of water or food 4 may be heated to the desired temperature. The remaining water or food 5 may be slowly heated slowly as a consequence of this.

The movement of the screen may optionally be automated. The timing of the movement of the screen may be controlled by a timer, for example.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

1. A food preparation method, comprising the steps of:
placing water or food inside a container;
heating the water or food within the container;
after heating said water or food, subsequently dividing said heated water or food into a portion to be heated further and a remaining portion.

2. The food preparation method, according to claim 1, wherein: said water or food is in a liquid, semi-liquid or solid state when it is placed inside the container.

3. The food preparation method, according to claim 2, wherein: when said water or food is in a solid state it is heated to achieve a liquid or semi-liquid state.

4. The food preparation method, according to claim 1, wherein: said step of dividing said water or food occurs after a predetermined amount of time.

5. The food preparation method, according to claim 1, wherein: said step of dividing said water or food occurs when said water or food is required, a certain period of time after said heating step.

6. The food preparation method, according to claim 1, wherein: said step of dividing said heated water or food into a portion to be heated further and said remaining portion occurs within said container.

7. The food preparation method, according to claim 1, wherein: said remaining portion of water or food is further divided into a portion to be heated further and a further remaining portion.

8. A food preparation method, comprising the steps of:
placing water or food inside a container;
said container, further comprising:
a heating base, a casing defining an inner volume, a lid on said casing opposite said heating base and removably closing said inner volume;
an internal screen assembly between said heating base and said lid operative to divide said inner volume into an upper portion distant said heating base and a lower portion proximate said heating base;
said internal screen assembly further including a screen support member and an internal screen member that is operative to move between an open condition distant from said screen support member and a closed condition sealingly contacting said screen support member;
initially moving said internal screen member to said screen support member;
heating said water or food within said container;
after heating said water or food, subsequently dividing said inner volume and said water or food into a heating portion and into a preserving portion; and
conducting further heating of said heating portion.

9. The food preparation method, according to claim 8, wherein: said water or food may be in the liquid, semi-liquid or solid state when it is placed inside the container.

10. The food preparation method, according to claim 9, wherein: when said water of food is in a solid state it is heated to achieve a liquid or semi-liquid state.

11. The food preparation method according to claim 8, wherein: the step of dividing said water or food occurs after a predetermined amount of time.

12. The food preparation method, according to claim 8, wherein: said step of dividing said water or food occurs when said water or food is required, a certain period of time after said heating step.

13. A food preparation method, comprising the steps of:
placing water or food inside a container;
said container further comprising:
a heating base, a casing defining an inner volume, a lid on said casing opposite said heating base and removably closing said inner volume;
an internal ladle located between said heating base and said lid;
said internal ladle being arranged to move between a lowered condition close to the heating base in order to collect and divide a portion of said water or food, and a raised condition which is distant from said heating base;
heating said water or food within said container;
after heating said water or food, using the ladle to collect a portion of said water or food from proximate the heating base and raising the ladle to the raised condition which is distant from said heating base, where the portion of water or food within the ladle forms a preserving portion and the portion of water or food proximate the base forms the heating portion; and
conducting further heating of said heating portion.

14. The food preparation method, according to claim 13, wherein: said water or food may be in the liquid, semi-liquid or solid state when it is placed inside the container.

15. The food preparation method, according to claim 14, where: when said water of food is in a solid state it is heated to achieve a liquid or semi-liquid state.

16. The food preparation method, according to claim 13, wherein: said step of dividing said water or food occurs after a predetermined amount of time.

17. The food preparation method, according to claim 13, wherein: said step of dividing said water or food occurs when said water or food is required, a certain period of time after said heating step.
